(19) United States
(12) Patent Application Publication
(10) Pub. No.: US 2013/0223897 A1
(43) Pub. Date: Aug. 29, 2013

(54) IMAGE FORMING APPARATUS

(71) Applicant: Fuji Xerox Co., Ltd., (US)

(72) Inventors: Tetsuji OKAMOTO, Kanagawa (JP); Masahiro SATO, Kanagawa (JP); Atsushi OGIHARA, Kananagawa (JP); Koichi WATANABE, Kanagawa (JP); Shuichi NISHIDE, Kanagawa (JP); Wataru SUZUKI, Kanagawa (JP); Atsuyuki KITAMURA, Kanagawa (JP)

(73) Assignee: Fuji Xerox Co., Ltd., Tokyo (JP)

(21) Appl. No.: 13/644,887

(22) Filed: Oct. 4, 2012

(30) Foreign Application Priority Data
Feb. 27, 2012 (JP) 2012-040359

(51) Int. Cl. G03G 15/01

(52) U.S. Cl. 399/304

(57) ABSTRACT

An image forming apparatus includes an image carrier, a transfer body transporting a recording medium to a transfer position multiple times in order to sequentially transfer toner images formed on a surface of the image carrier to the recording medium, a trailing-end restricting member that is movable relative to the transfer body in a circumferential direction of the transfer body, the trailing-end restricting member rotating together with the transfer body when restricting a position of a trailing end portion of the recording medium wrapped around the transfer body, a driving member that rotates the transfer body, and a transmitting device that transmits a rotary force, with which the driving member rotates the transfer body, to the trailing-end restricting member when the trailing-end restricting member is rotated together with the transfer body.

### CROSS-REFERENCE TO RELATED APPLICATIONS

This application is based on and claims priority under 35 USC 119 from Japanese Patent Application No. 2012-040359 filed Feb. 27, 2012.

### BACKGROUND

The present invention relates to image forming apparatuses.

### SUMMARY

An image forming apparatus according to an aspect of the present invention includes an image carrier on whose surface toner images are sequentially formed while the image carrier is rotating, a transfer body around whose outer circumferential surface a recording medium is wrapped, the transfer body transporting the recording medium to a transfer position, at which the recording medium faces the image carrier, multiple times in order to sequentially transfer the toner images formed on the surface of the image carrier to the recording medium while the image carrier is rotating, a trailing-end restricting member that is movable relative to the transfer body in a circumferential direction of the transfer body, the trailing-end restricting member rotating together with the transfer body when restricting a position of a trailing end portion of the recording medium wrapped around the transfer body, a driving member that rotates the transfer body; and a transmitting device that transmits a rotary force, with which the driving member rotates the transfer body, to the trailing-end restricting member when the trailing-end restricting member is rotated together with the transfer body.

### BRIEF DESCRIPTION OF THE DRAWINGS

Exemplary embodiments of the present invention will be described in detail based on the following figures, wherein:

FIGS. 1A and 1B are front views of components, such as a trailing-end gripper and a transfer drum, of an image forming apparatus according to a first exemplary embodiment of the invention;

FIGS. 2A and 2B are side views of a leading-end gripper of the image forming apparatus according to the first exemplary embodiment of the invention that is positioned so as to be in a releasing state and a gripping state;

FIG. 3A is a developed view of a transfer drum, a leading-end gripper, and a trailing-end gripper of the image forming apparatus according to the first exemplary embodiment of the invention, and FIG. 3B is a side view of the transfer drum, the leading-end gripper, and the trailing-end gripper;

FIGS. 4A to 4D illustrate a series of states in which a sheet medium is wrapped around the transfer drum of the image forming apparatus according to the first exemplary embodiment of the invention;

FIGS. 5A to 5D illustrate a series of states in which a sheet medium that has been wrapped around the transfer drum of the image forming apparatus according to the first exemplary embodiment of the invention is separated from the transfer drum;

FIG. 6 is a side view of components, such as the transfer drum and an image carrier, of the image forming apparatus according to the first exemplary embodiment of the invention;

FIG. 7 schematically illustrates the image forming apparatus according to the first exemplary embodiment of the invention;

FIGS. 8A and 8B are front views of components, such as a trailing-end gripper and a transfer drum, of an image forming apparatus according to a second exemplary embodiment of the invention;

FIG. 9 is a perspective view of a side surface of the transfer drum and a side surface of a roller of the image forming apparatus according to the second exemplary embodiment of the invention;

FIGS. 10A and 10B are front views of components, such as a trailing-end gripper and a transfer drum, of an image forming apparatus according to a third exemplary embodiment of the invention;

FIGS. 11A and 11B are front views of components, such as a trailing-end gripper and a transfer drum, of an image forming apparatus according to a fourth exemplary embodiment of the invention;

FIGS. 12A and 12B are front views of components, such as a trailing-end gripper and a transfer drum, of an image forming apparatus according to a fifth exemplary embodiment of the invention;

FIG. 13 is an enlarged front view of components, such as the trailing-end gripper and the transfer drum, of the image forming apparatus according to the fifth exemplary embodiment of the invention;

FIG. 14 is a perspective view of components, such as the trailing-end gripper and the transfer drum, of the image forming apparatus according to the fifth exemplary embodiment of the invention; and

FIGS. 15A and 15B are front views of components, such as a trailing-end gripper and a transfer drum, of an image forming apparatus according to a sixth exemplary embodiment of the invention.

### DETAILED DESCRIPTION

### First Embodiment

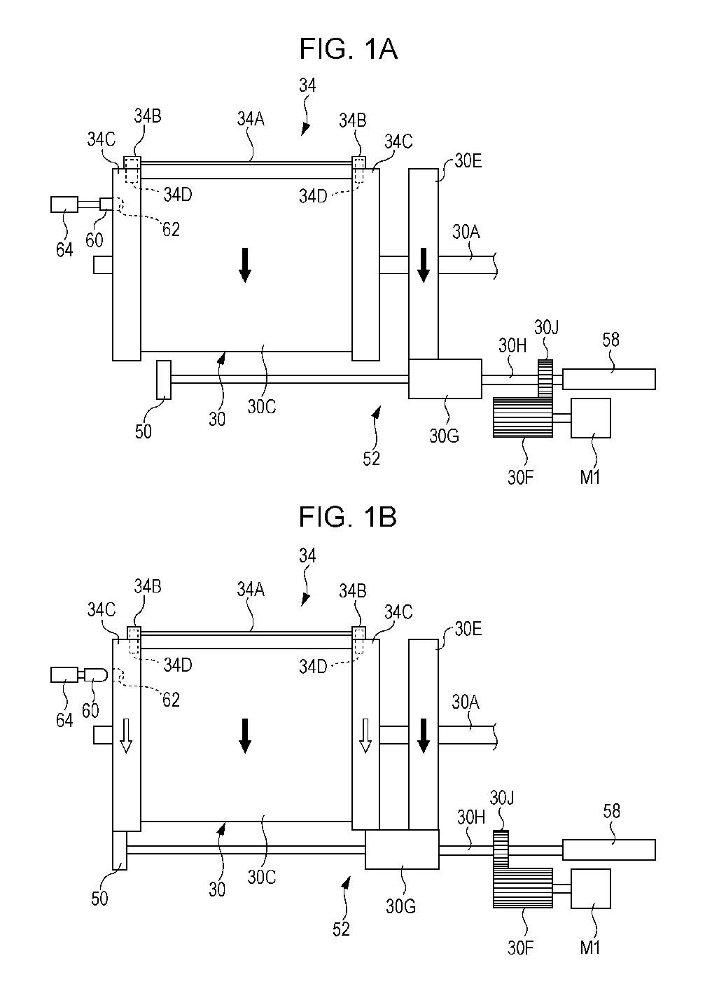

An image forming apparatus 10 according to a first exemplary embodiment of the invention will be described referring to FIGS. 1A to 7.

### Entire Configuration

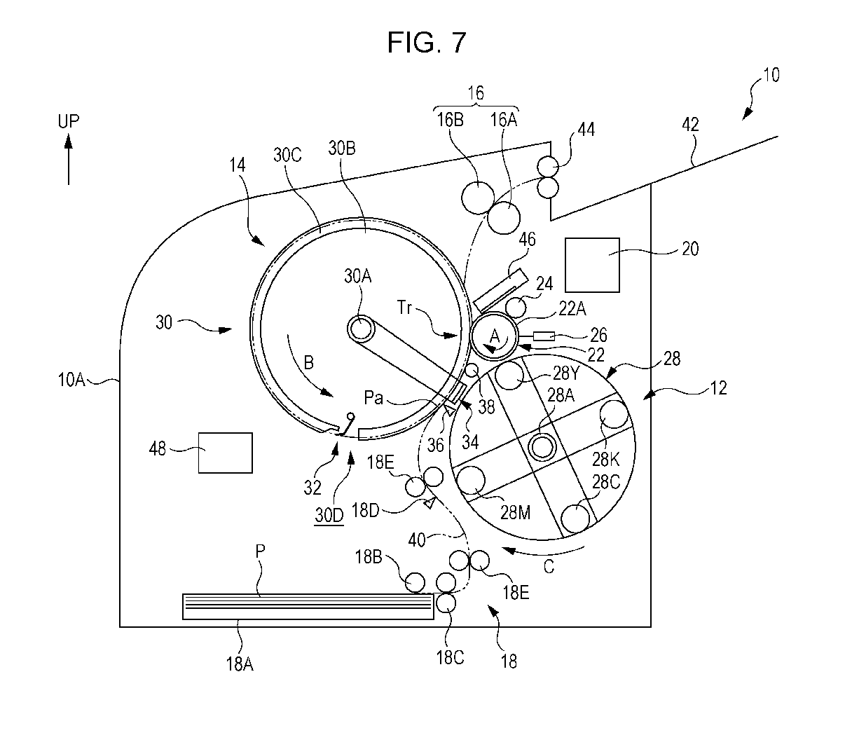

As illustrated in FIG. 7, the image forming apparatus 10 according to the exemplary embodiment of the present invention includes an image forming unit 12, a transfer device 14, a fixing device 16, a sheet feeding unit 18, and a controlling unit 20. The image forming unit 12 forms a toner image. A sheet medium P is a recording medium and is fed to the transfer device 14, and the transfer device 14 transfers the toner image, having been formed by the image forming unit 12, to the sheet medium P that is wrapped around the transfer device 14. The fixing device 16 fixes the toner image, having been formed on the sheet medium P released from the transfer device 14, onto the sheet medium P. The sheet feeding unit 18 feeds the sheet medium P to the transfer device 14. The controlling unit 20 controls the entirety of the image forming apparatus 10.

### Image Forming Unit

The image forming unit 12 that forms a toner image will be described first.

The image forming unit 12 includes an image carrier 22, on whose surface toner images are sequentially formed while the image carrier 22 is rotating. The image forming unit 12 also includes a charging device 24, an exposing device 26, a rotary developing device 28, and a cleaning device 46. The charging device 24 charges the surface of the image carrier 22. The exposing device 26 exposes the charged surface of the image carrier 22 to light to form an electrostatic latent image. The rotary developing device 28 develops the electrostatic latent image, having been formed on the surface of the image carrier 22, by using a developer into a toner image. The cleaning device 46 removes remnants remaining on the image carrier 22.

### Image Carrier

The image carrier 22 is disposed so as to rotate in the arrow A direction and includes a negatively charged photosensitive layer 22A on its surface. The charging device 24, the exposing device 26, the rotary developing device 28, and the cleaning device 46 are arranged around the image carrier 22 in this order in the arrow A direction. A driving source (not illustrated) that drives the image carrier 22 to rotate at a peripheral velocity V1 is also provided.

### Charging Device

The charging device 24 is disposed so as to face the image carrier 22. While the charging device 24 is driven to rotate by the rotating image carrier 22, the charging device 24 charges the surface of the image carrier 22.

### Exposing Device

The exposing device 26 irradiates the surface of the image carrier 22 having been charged by the charging device 24 with light to form an electrostatic latent image. In this exemplary embodiment, the exposing device 26 includes, for example, multiple light emitting diodes (LEDs, which are not illustrated).

### Rotary Developing Device

The rotary developing device 28 includes a rotation shaft 28A and developing portions 28Y, 28M, 28C, and 28K for yellow (Y), magenta (M), cyan (C), and black (K) arranged around the rotation shaft 28A. The rotary developing device 28 rotates in the arrow C direction around the rotation shaft 28A.

In the rotary developing device 28, each of the developing portions 28Y, 28M, 28C, and 28K is positioned at a position at which the developing portion faces the image carrier 22. Then, the rotary developing device 28 sequentially develops electrostatic latent images on the image carrier 22 having been formed by the exposing device 26 into toner images of the different colors.

These developing portions 28Y, 28M, 28C, and 28K contain developers of corresponding colors.

### Cleaning Device

The cleaning device 46 recovers toner remaining on the surface of the image carrier 22 without being transferred to the sheet medium P by the transfer device 14, which will be described below, or other extraneous matters from the surface of the image carrier 22. The cleaning device 46 according to the exemplary embodiment is a blade-type cleaner.

### Transfer Device

Now, description will be given on the transfer device 14 around which a sheet medium P is wrapped and that transfers a toner image having been formed by the image forming unit 12 to the wrapped sheet medium P.

The transfer device 14 includes a transfer drum 30, a leading-end gripper 32, and a trailing-end gripper 34. The transfer drum 30 is taken as an example of a transfer body around which a sheet medium P, to which a toner image on the image carrier 22 is transferred, is wrapped. The leading-end gripper 32 is taken as an example of a leading-end gripping member that grips a leading end portion of the sheet medium P that is wrapped around the transfer drum 30. The trailing-end gripper 34 is taken as an example of a trailing-end restricting member that restricts the position of a trailing end portion of the sheet medium P.

The transfer device 14 also includes a sheet sensor 36 that detects a sheet medium P passing thereby, a pressing roller 38 that presses the sheet medium P against the transfer drum 30, a driving motor M1 (see FIGS. 1A and 1B) that drives the transfer drum 30 to rotate, and a power source 48 that applies a transfer bias, which is a voltage of a polarity opposite to that of the toner, to the transfer drum 30. The trailing-end gripper 34 will be described in detail below.

### Transfer Drum

The transfer drum 30 arranged so as to face the image carrier 22 includes a rotation shaft 30A, a drum-shaped base portion 30B, and an elastically deformable elastic layer 30C that is formed around the outer circumferential surface of the base portion 30B.

The elastic layer 30C, from a leading end to a trailing end of the elastic layer 30C in a direction in which the sheet medium P is transported, follows the shape of the outer circumference of the drum-shaped base portion 30B. A portion of the transfer drum 30, around which even a maximum-size sheet medium P is not wrapped, is a cutout region 30D in which the elastic layer 30C is absent such that a part of the elastic layer 30C in the circumferential direction of the transfer drum 30 is cut out.

The dimensions of the transfer drum 30 and the image carrier 22 and the positional relationships between the transfer drum 30 and the image carrier 22 are determined such that the transfer drum 30 and the image carrier 22 do not contact each other when the cutout region 30D of the transfer drum 30 faces the image carrier 22. A dielectric substance, such as a dielectric sheet, is not attached to the outer circumferential surface of the elastic layer 30C, and thus wrapping of a sheet medium P around the transfer drum 30 does not involve the use of electrostatic attraction.

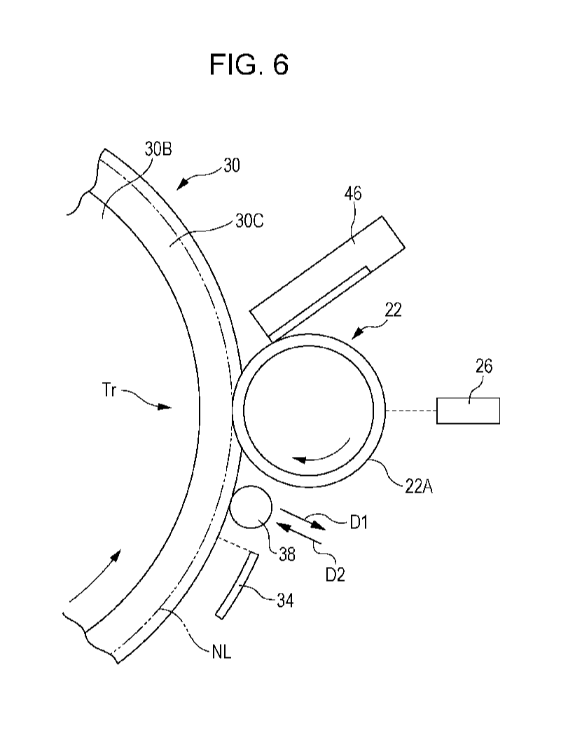

As illustrated in FIG. 6, at a transfer position Tr at which the transfer drum 30 and the image carrier 22 face each other to transfer a toner image to the sheet medium P, the elastic layer 30C of the transfer drum 30 is pressed by the image carrier 22. The elastic layer 30C is then pressed by the image carrier 22 down to a compressed circumference NL illustrated in FIG. 6 with the two-dot chain line.

At the transfer position Tr, transporting of the sheet medium P that is nipped by the transfer drum 30 and the image carrier 22 is performed dominantly by using electrostatic attraction of the image carrier 22.

As illustrated in FIGS. 1A and 1B, a roller 30E is mounted on a first end portion of a rotation shaft 30A of the transfer drum 30. A rotation shaft 30H that extends in a direction of the rotation shaft 30A of the transfer drum (also simply referred to as a “drum-axis direction” below) is disposed at a distance from the transfer drum 30. A roller 30G that is capable of transmitting a rotary force between itself and the roller 30E by contacting the outer circumferential surface of the roller 30E is mounted on the rotation shaft 30H. The roller 30G is longer than the roller 30E in the drum-axis direction.

A gear 30J that meshes with a gear 30F mounted on an output shaft of the driving motor M1, which is an example of a driving member that drives the transfer drum 30 to rotate, is mounted on the rotation shaft 30H. The transfer drum 30 is driven to rotate by the driving force of the driving motor M1 at a peripheral velocity V2, which is lower than a peripheral velocity V1 of the image carrier 22. The gear 30F is longer than the gear 30J in the drum-axis direction.

### Sheet Sensor

As illustrated in FIG. 7, the sheet sensor 36 is disposed so as to face the outer circumferential surface of the transfer drum 30. The sheet sensor 36 irradiates the sheet medium P, which is transported while being wrapped around the transfer drum 30, with infrared light, and detects the sheet medium P passing thereby using the reflected light.

The sheet sensor 36 is disposed upstream from a stand-by position of the trailing-end gripper 34 (the position of the trailing-end gripper 34 illustrated in FIG. 7), which will be described below, in the direction in which the sheet medium P is transported, and downstream from a feeding-sheet position Pa, at which a sheet medium P is fed to the transfer drum 30, in the direction in which the sheet medium P is transported.

### Pressing Roller

The pressing roller 38 that presses a sheet medium P against the transfer drum 30 is disposed upstream from the transfer position Tr in the direction in which the sheet medium P is transported, and downstream from the stand-by position of the trailing-end gripper 34 in the direction in which the sheet medium P is transported.

The pressing roller 38 moves toward or away from the transfer drum 30 (see the arrows D1 and D2 illustrated in FIG. 6).

### Leading-End Gripper

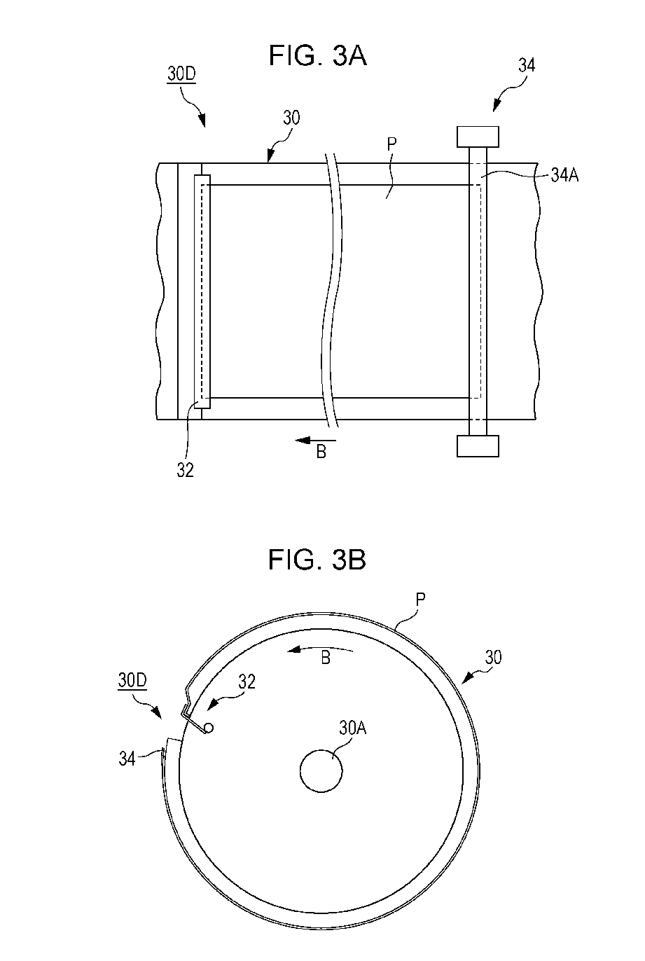

As illustrated in FIGS. 3A and 3B, the leading-end gripper 32 that grips the leading end portion of the sheet medium P wrapped around the transfer drum 30 is attached to the transfer drum 30, and is disposed in the cutout region 30D. FIG. 3A is a developed view in which the outer circumference of the transfer drum 30 is developed.

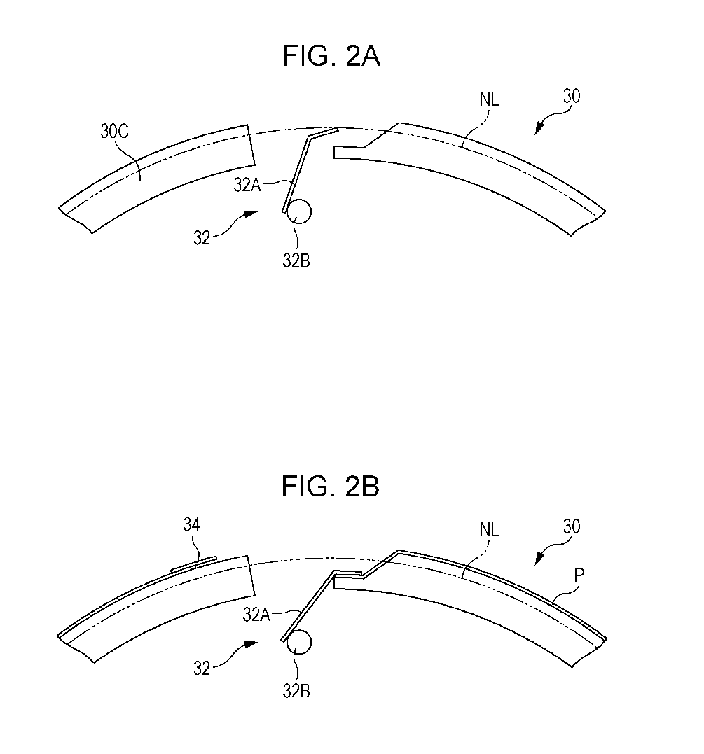

As illustrated in FIGS. 2A and 2B, the leading-end gripper 32 includes a pressing plate 32A and a shaft member 32B. The pressing plate 32A presses the leading end portion of the sheet medium P against the elastic layer 30C. The shaft member 32B rotates the pressing plate 32A such that the pressing plate 32A grips or releases the leading end portion of the sheet medium P.

The pressing plate 32A extends in the drum axis direction. For example, the pressing plate 32A is formed by bending a stainless steel plate, and has a single bent portion when viewed in the drum axis direction.

An axis direction of the shaft member 32B is parallel to the drum axis direction. The shaft member 32B, which is cylindrical, is secured to a first end portion of the pressing plate 32A. Accordingly, when the shaft member 32B is rotated, the leading-end gripper 32 moves so as to switch between a gripping state, in which a second end portion of the pressing plate 32A grips the leading end portion of the sheet medium P (see FIG. 2B), and a releasing state, in which the second end portion releases the leading end portion of the sheet medium P (see FIG. 2A).

As illustrated in FIGS. 2A and 2B, a locus of the leading-end gripper 32 that moves so as to switch between the gripping state and the releasing state is formed on the inner side of the compressed circumference NL, and thus the leading-end gripper 32 does not contact the image carrier 22. In other words, the leading-end gripper 32 is located outside a region within which the image carrier 22 compresses the elastic layer 30C, and thus when the leading-end gripper 32 has been moved to the transfer position Tr, the leading-end gripper 32 is separated from the image carrier 22.

### Fixing Device

The fixing device 16 that fixes a toner image formed on a sheet medium P onto the sheet medium P will be described now.

As illustrated in FIG. 7, the fixing device 16 includes a heating roller 16A and a pressurizing roller 16B. The heating roller 16A includes a heating source (not illustrated) and a rotary force is transmitted to the heating roller 16A. The pressurizing roller 16B is in contact with the heating roller 16A with pressure.

When a sheet medium P holding a toner image is nipped between and transported by the heating roller 16A and the pressurizing roller 16B, the toner image is melted and pressurized and is thus fixed onto the sheet medium P.

Discharging rollers 44 are disposed downstream from the fixing device 16 in the direction in which the sheet medium P is transported. The discharging rollers 44 discharge the sheet medium P, having a toner image fixed thereon, to a discharge portion 42 formed on an upper surface of an apparatus body 10A.

### Sheet Feeding Unit

Now, the sheet feeding unit 18 that feeds a sheet medium P to the transfer device 14 will be described.

The sheet feeding unit 18 is disposed at a lower portion in the apparatus body 10A of the image forming apparatus 10 and includes a sheet containing member 18A, a pick-up roller 18B, separation rollers 18C, and a leading-end sensor 18D. The sheet containing member 18A contains sheet media P. The pick-up roller 18B picks up the sheet media P from the sheet containing member 18A. The separation rollers 18C separate closely-attached sheet media P from each other. The leading-end sensor 18D detects the leading end portion of a sheet medium P passing thereby.

The sheet feeding unit 18 also includes multiple transporting rollers 18E. Each sheet medium P is transported by the transporting rollers 18E along a transport path 40.

In this manner, each sheet medium P is transported along the transport path 40 from the sheet containing member 18A to the feeding-sheet position Pa, which is positioned upstream from the transfer position Tr in the direction of rotation of the transfer drum 30.

### Operations of Entire Configuration

Now, operations of the entire configuration will be described.

Firstly, color image data that has been formed by a personal computer or the like, which is not illustrated, is input to an image signal processor (not illustrated) as red (R), green (G), and blue (B) data, for example, and is then subjected to image processing. The image data that has been subjected to image processing is converted into four-color gradation data for yellow (Y), magenta (M), cyan (C), and black (K), which is output to the exposing device 26, so that an image forming operation is started.

With the start of the image forming operation, the image carrier 22 and the transfer drum 30 start rotating together as illustrated in FIG. 7. Here, the peripheral velocity V1 of the image carrier 22 is higher than the peripheral velocity V2 of the transfer drum 30. For example, the peripheral velocity V1 of the image carrier 22 is approximately 0.5% to 1% higher than the peripheral velocity V2 of the transfer drum 30.

At this time, the leading-end gripper 32 and the trailing-end gripper 34 are in the releasing state.

While the leading-end gripper 32 rotates together with the transfer drum 30, the trailing-end gripper 34 remains stationary at the stand-by position while being in the releasing state without rotating together with the transfer drum 30.

After the photosensitive layer 22A of the rotating image carrier 22 is charged by the charging device 24, the exposing device 26 irradiates the image carrier 22 with light so that an electrostatic latent image for a first color (yellow, for example) based on the image information is formed on the image carrier 22.

Meanwhile, the rotary developing device 28 rotates so that a developing portion containing a toner of the color corresponding to the electrostatic latent image to be formed on the image carrier 22 (the yellow developing portion 28Y, if the corresponding color is yellow) is positioned at a position opposite the image carrier 22.

Thereafter, the developing portion 28Y develops the electrostatic latent image on the image carrier 22 to form a toner image on the image carrier 22. This toner image is transported toward the transfer position Tr, at which the toner image faces the transfer drum 30, with the rotation of the image carrier 22.

With the start of the image forming operation, feeding of a sheet medium P is also started. Specifically, sheet media P that are picked up from the sheet containing member 18A by the pick-up roller 18B are separated by the separation rollers 18C. The separated sheet media P are forwarded to the transport path 40 by the transporting rollers 18E. The leading-end sensor 18D then detects the leading end portion of each sheet medium P passing thereby and transmits a detection signal to the controlling unit 20.

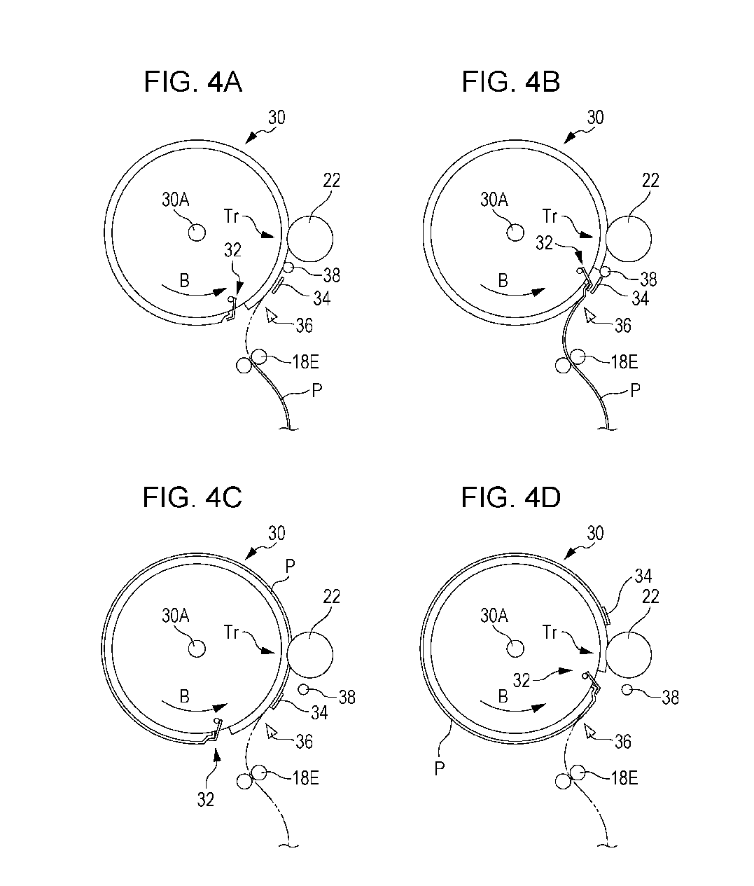

The controlling unit 20 that has received the detection signal controls transportation of the sheet medium P on the basis of the detection signal such that the sheet medium P arrives at the feeding-sheet position Pa at the same time as when the leading-end gripper 32 arrives at the feeding-sheet position Pa (see FIG. 4A).

Here, at the time of feeding the sheet medium P, information on the size of the sheet medium P that has been detected by a sheet-size sensor (not illustrated) is transmitted to the controlling unit 20.

As illustrated in FIG. 4B, the leading-end gripper 32 that has been in the releasing state switches to the gripping state at the same time as when the leading end portion of the sheet medium P arrives at the feeding-sheet position Pa. The leading end portion of the sheet medium P is thus gripped by the leading-end gripper 32.

The leading-end gripper 32 gripping the sheet medium P then passes a position opposite the stationary trailing-end gripper 34. The leading-end gripper 32 having passed the trailing-end gripper 34 then moves toward the transfer position Tr while gripping the sheet medium P. Here, the pressing roller 38 is positioned at a contact position, at which the pressing roller 38 contacts the elastic layer 30C, and presses the sheet medium P against the elastic layer 30C such that the sheet medium P is wrapped around the transfer drum 30 so as to follow the shape of the elastic layer 30C.

The sheet medium P that has passed the transfer position Tr while being gripped by the leading-end gripper 32 is consequently wrapped around the transfer drum 30 while being gripped by the leading-end gripper 32, as illustrated in FIG. 4C.

The toner image of the first color (yellow, for example) formed on the image carrier 22 is transferred to the sheet medium P on the transfer drum 30 at the transfer position Tr at which the image carrier 22 and the transfer drum 30 face each other. Part of toner remaining on the image carrier 22 after the transfer is recovered from the image carrier 22 by the cleaning device 46 (see FIG. 6).

Thereafter, the sheet sensor 36 detects the trailing end portion of the sheet medium P passing thereby. The controlling unit 20 that has received a signal from the sheet sensor 36 sends an instruction to the trailing-end gripper 34 and the pressing roller 38.

The trailing-end gripper 34 having received the instruction switches from the releasing state to the restricting state, which will be described below, to restrict the position of the trailing end portion of the sheet medium P. The pressing roller 38 having received the instruction moves from the contact position to a separation position to become separated from the sheet medium P.

The trailing-end gripper 34 that has switched to the restricting state starts rotating together with the transfer drum 30. In other words, the sheet restricting member 34A of the trailing-end gripper 34 moves at the same velocity as the peripheral velocity V2 of the transfer drum 30.

As illustrated in FIG. 4D, the trailing-end gripper 34 rotating together with the transfer drum 30 passes the transfer position Tr while restricting the trailing end portion of the sheet medium P.

Likewise, forming and developing of latent images for second and subsequent colors (magenta and cyan, for example), which precede a final color (black, for example), and transferring of toner images corresponding to the latent images is repeated in accordance with the above-described procedure.

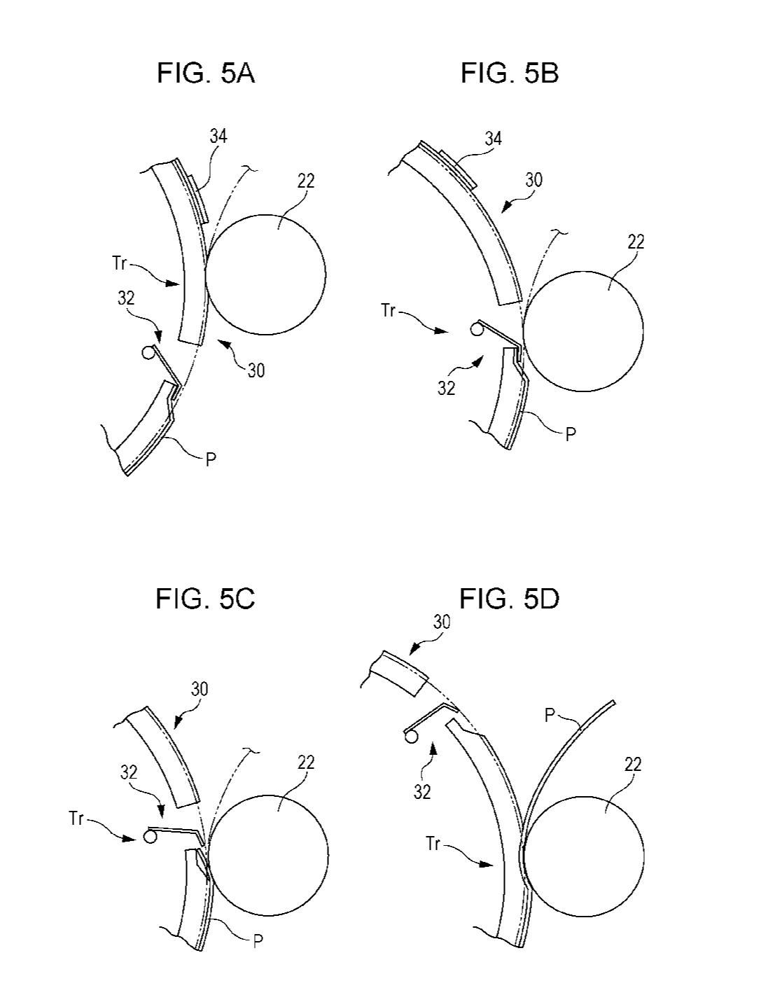

As illustrated in FIGS. 5A and 5B, in the case of transferring a toner image of a final color (black, for example), the leading-end gripper 32 switches from the gripping state to the releasing state at the transfer position Tr, unlike in the case of transferring a toner image of a color that precedes the final color.

As illustrated in FIGS. 5C and 5D, when the leading-end gripper 32 releases the leading end portion of the sheet medium P on which multiple toner images are formed, the leading end portion becomes separated from the transfer drum 30 due to having been nipped by the elastic layer 30C and the image carrier 22.

The sheet medium P whose leading end portion is separated from the transfer drum 30 is transported toward the fixing device 16 illustrated in FIG. 7.

As the sheet medium P is transported further, the trailing-end gripper 34 that restricts the trailing end portion of the sheet medium P arrives at the stand-by position. At the stand-by position, the trailing-end gripper 34 switches from the restricting state to the releasing state to release the trailing end portion of the sheet medium P. The trailing-end gripper 34 that has switched to the releasing state stops at the stand-by position.

The toner images on the sheet medium P having been transported to the fixing device 16 are fixed onto the sheet medium P by the fixing device 16. As the sheet medium P is transported further, the sheet medium P becomes separated from the transfer drum 30. The sheet medium P is finally discharged to the discharge portion 42 by the discharging rollers 44.

### Configuration of Related Portion

Now, the trailing-end gripper 34 will be described.

As illustrated in FIGS. 1A and 1B, the trailing-end gripper 34 is disposed so as to stretch over the transfer drum 30 in the drum-axis direction.

The trailing-end gripper 34 includes a sheet restricting member 34A, which is an example of a restricting member that extends in the drum-axis direction, a pair of protectors 34B attached to both end portions of the sheet restricting member 34A, and a pair of rollers 34C to which base end portions of the protectors 34B are secured, the rollers 34C being supported by the rotation shaft 30A so as to be rotatable relative to the rotation shaft 30A.

The outside diameter of the rollers 34C is the same as the outside diameter of the roller 30E, but larger than the outside diameter of the transfer drum 30. The base end portion of each protector 34B is secured to a portion of the outer circumferential surface of a corresponding roller 34C that is on a transfer-drum-30 side in the drum-axis direction.

The sheet restricting member 34A is made of a film-formed resin material and is elastically deformable. Examples of the resin material include polyethylene terephthalate (PET), polyimide, and fluorocarbon resins.

The trailing-end gripper 34 also includes solenoids 34D each disposed inside a corresponding one of the protectors 34B and a corresponding one of the rollers 34C. The solenoids 34D move the sheet restricting member 34A in a radial direction of the transfer drum 30 (may simply be referred to as a “drum-radius direction” below).

In this configuration, the controlling unit 20 (see FIG. 7) controls the solenoids 34D such that the sheet restricting member 34A moves outward in the drum-radius direction. Consequently, the sheet restricting member 34A switches to a releasing state in which the sheet restricting member 34A becomes separated from the elastic layer 30C to release the trailing end portion of the sheet medium P (see FIG. 1A).

On the other hand, the controlling unit 20 controls the solenoids 34D such that the sheet restricting member 34A moves inward in the drum-radius direction. Consequently, the sheet restricting member 34A switches to a restricting state in which the sheet restricting member 34A restricts the trailing end portion of the sheet medium P by bringing the trailing end portion into contact with the elastic layer 30C to cause the trailing end portion to follow the shape of the elastic layer 30C (see FIG. 1B).

A roller 50 having the same outside diameter as the roller 30G is mounted on the rotation shaft 30H on a side that is opposite the side on which the roller 30J is located with respect to the roller 30G.

The roller 50 mounted on the rotation shaft 30H, the roller 30G, and the gear 30J constitute a rotary-force transmitting unit 52, which is an example of a transmitting unit that transmits a rotary force, with which the driving motor M1 rotates the transfer drum 30, to the trailing-end gripper 34, as will be described below.

A supporting member (not illustrated) that supports the rotary-force transmitting unit 52 such that the rotary-force transmitting unit 52 is movable in the drum-axis direction is also provided. A range of movement of the rotary-force transmitting unit 52 is restricted by a stopper member, which is not illustrated. As illustrated in FIGS. 1A and 1B, the rotary-force transmitting unit 52 is movable between a contact position at which the roller 50 and the roller 30G contact the rollers 34C (see FIG. 1B) and a separation position at which the roller 50 and the roller 30G are separated from the rollers 34C (see FIG. 1A). A solenoid 58 that moves the rotary-force transmitting unit 52 between the contact position and the separation position is also provided. Specifically, the rotary-force transmitting unit 52 is positioned at the separation position when an electric current is not passed through the solenoid 58, while the rotary-force transmitting unit 52 is moved to the contact position when an electric current is passed through the solenoid 58.

Specifically, when the rotary-force transmitting unit 52 is positioned at the contact position as illustrated in FIG. 1B, the roller 30G is positioned so as to stretch in the drum-axis direction between the roller 30E and one of the rollers 34C that is on the roller-30E side and contacts the roller 30E and the roller 34C on the roller-30E side (referred to as a “first roller 34C”, when needed). The roller 50 contacts the other roller 34C disposed on a side that is opposite the first roller 34C with respect to the transfer drum 30 (the other roller 34C is referred to as a “second roller 34C”, when needed).

When the rotary-force transmitting unit 52 is positioned at the separation position as illustrated in FIG. 1A, on the other hand, the roller 50 and the roller 30G are separated from the rollers 34C in the drum-axis direction while the roller 30E and the roller 30G remain contacting each other.

The image forming apparatus 10 also includes a positioning pin 60 with which the trailing-end gripper 34 is positioned at the stand-by position. A recess 62 into which a tip portion of the positioning pin 60 is inserted is formed in a side surface of the second roller 34C. A solenoid 64 that moves the positioning pin 60 to insert the positioning pin 60 into or withdraw the positioning pin 60 from recess 62 is also provided.

When the positioning pin 60 is in an inserted state in which the positioning pin 60 is inserted in the recess 62, the trailing-end gripper 34 is positioned at the stand-by position (see FIG. 1A). On the other hand, when the positioning pin 60 is in a withdrawn state in which the positioning pin 60 is withdrawn from the recess 62, the trailing-end gripper 34 is allowed to rotate around the rotation shaft 30A.

### Operations of Related Portions

As illustrated in FIG. 7, when the image forming operation is started, the image carrier 22 and the transfer drum 30 start rotating together.

In this state, as illustrated in FIG. 1A, the controlling unit 20 (see FIG. 7) controls the solenoid 64 such that the positioning pin 60 switches to the inserted state, and thus the trailing-end gripper 34 is positioned at the stand-by position. The controlling unit 20 also controls the solenoids 34D such that the trailing-end gripper 34 switches to the releasing state. The controlling unit 20 also controls the solenoid 58 such that the rotary-force transmitting unit 52 is positioned at the separation position.

The leading end portion of the sheet medium P that has been transported along the transport path 40 illustrated in FIG. 7 is gripped by the leading-end gripper 32, and thus the sheet medium P is wrapped around the rotating transfer drum 30.

When the trailing end portion of the sheet medium P that is wrapped around the transfer drum 30 arrives at the sheet restricting member 34A, the controlling unit 20 controls the solenoid 64 such that the positioning pin 60 switches to the withdrawn state, as illustrated in FIG. 1B. This allows the trailing-end gripper 34 to rotate around the rotation shaft 30A. Concurrently, the controlling unit 20 controls the solenoid 58 such that the rotary-force transmitting unit 52 moves to the contact position, so that a rotary force is transmitted from the driving motor M1 to the trailing-end gripper 34 via the rotary-force transmitting unit 52. Thus, the transfer drum 30 and the trailing-end gripper 34 rotate together. The controlling unit 20 also controls the solenoids 34D such that the trailing-end gripper 34 switches to the restricting state.

As described above, the rotary-force transmitting unit 52 is used to transmit the rotary force, with which the driving motor M1 rotates the transfer drum 30, to the trailing-end gripper 34. This improves accuracy in positioning of the trailing-end gripper 34 relative to the transfer drum 30 in terms of the circumferential direction of the transfer drum 30, compared to the case where the trailing-end gripper 34 and the transfer drum 30 are each provided with a transmitting unit. In the case where the trailing-end gripper 34 and the transfer drum 30 are each provided with a transmitting unit, each transmitting unit involves factors that degrade the positioning accuracy, such as a production tolerance or an installation tolerance of each part and a play between parts.

As a result of the improvement in accuracy of positioning the trailing-end gripper 34 relative to the transfer drum 30, the trailing-end-side area of the sheet medium P that is restricted by the sheet restricting member 34A is reduced. This leads to reduction of a trailing-end-side margin (a range in which a toner image is not formable) of the sheet medium P.

Moreover, the trailing-end gripper 34 is driven to rotate by the driving motor M1 for rotating the transfer drum 30. This eliminates the need for separately preparing a driving source for rotating the trailing-end gripper 34.

### Second Exemplary Embodiment

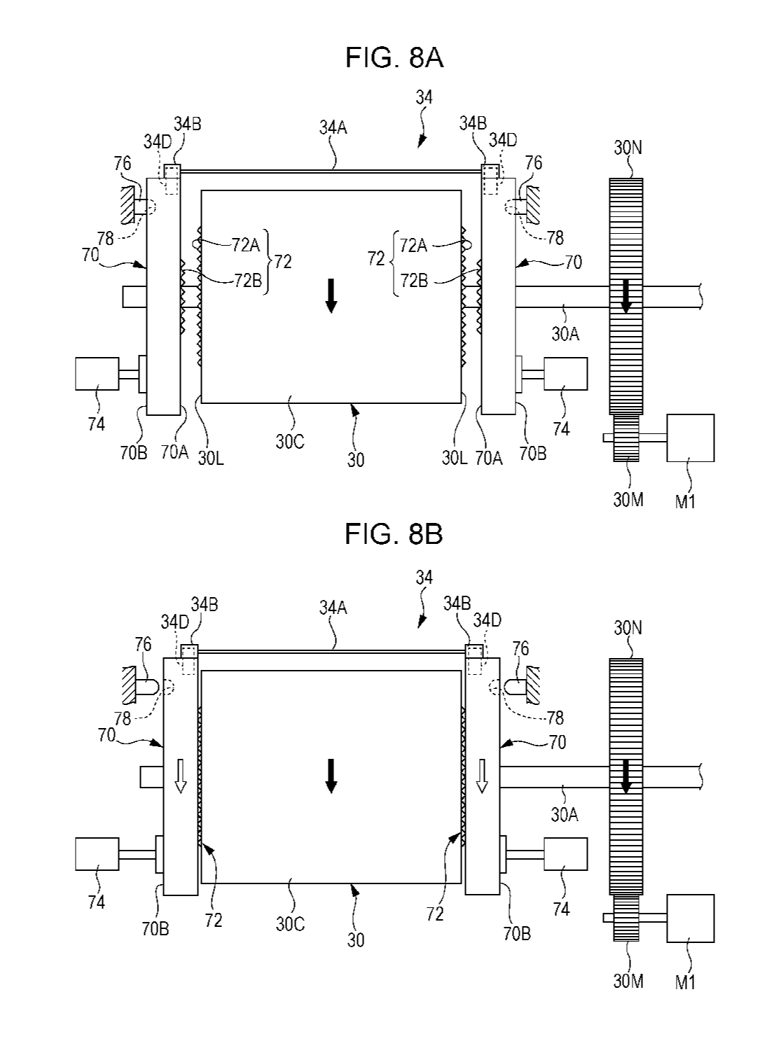

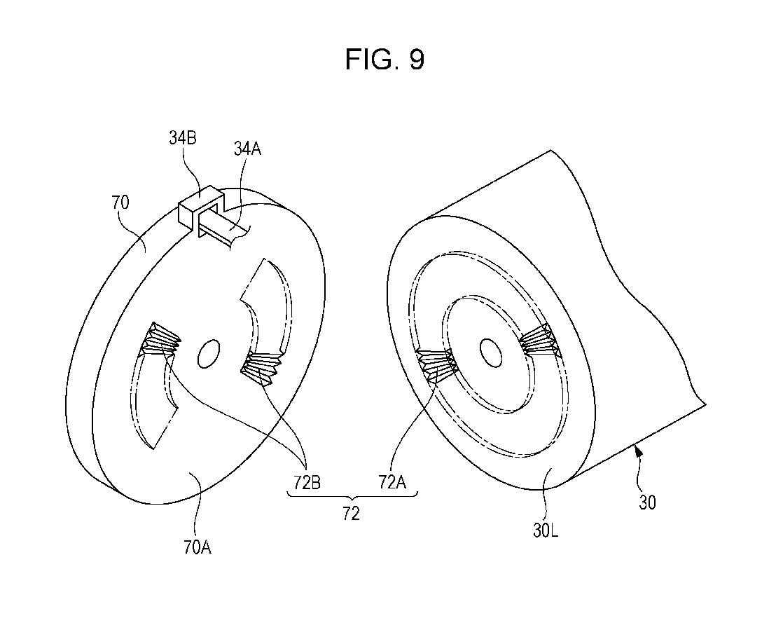

Referring now to FIGS. 8A to 9, an image forming apparatus according to a second exemplary embodiment of the invention will be described. Components that are the same as those in the first exemplary embodiment will be denoted by the same reference symbols and description thereof is not provided.

As illustrated in FIGS. 8A and 8B, a pair of rollers 70 according to the second exemplary embodiment, which are examples of a pair of components, to which base end portions of the protectors 34B are secured are supported by the rotation shaft 30A so as to be rotatable relative to the rotation shaft 30A and are movable relative to the rotation shaft 30A in the drum-axis direction.

A gear 30N that meshes with a gear 30M mounted on an output shaft of the driving motor M1 has a larger diameter than the gear 30M and is mounted on the rotation shaft 30A.

As illustrated in FIG. 9, on each side surface 30L of the transfer drum 30 that faces the roller 70, a meshing portion 72A having projections and depressions is annularly formed around the rotation axis of the transfer drum 30.

A pair of meshed portions 72B having projections and depressions are formed on a side surface 70A of each roller 70 that faces the transfer drum 30. The meshed portions 72B have an arc shape so as to be meshed with the meshing portion 72A as a result of movement of the roller 70 in the drum-axis direction. When the meshing portion 72A meshes with the meshed portions 72B, the trailing-end gripper 34 is joined to the transfer drum 30. In other words, joining systems 72 joining the rollers 70 to the transfer drum 30 each include a meshing portion 72A and a pair of meshed portions 72B.

As illustrated in FIGS. 8A and 8B, solenoids 74 are provided, which are examples of moving members that move the rollers 70 in the drum-axis direction toward or away from the transfer drum 30. An end portion of each solenoid 74 is disposed on a side surface 70B of a corresponding one of the rollers 70, the side surface 70B being opposite the side surface 70A. A bearing (not illustrated) is disposed between each solenoid 74 and a corresponding side surface 70B. Urging springs (not illustrated) are also provided to urge the rollers 70 toward the solenoids 74 such that the rollers 70 contact the solenoids 74. The rollers 70 are separated from the transfer drum 30 when electric currents are not passed through the solenoids 74, and the rollers 70 are brought into contact with the transfer drum 30 when electric currents are passed through the solenoids 74.

In this configuration, the controlling unit 20 controls the solenoids 74 such that the rollers 70 move between a separation position (see FIG. 8A), at which the rollers 70 are separated from the transfer drum 30, and an contact position (see FIG. 8B) at which the rollers 70 are in contact with the transfer drum 30 and the meshing portions 72A and the meshed portions 72B mesh with one another. When the rollers 70 are positioned at the contact position, a rotary force of the driving motor M1 is transmitted to the trailing-end gripper 34 via the transfer drum 30.

The image forming apparatus 10 also includes positioning pins 76 with which the trailing-end gripper 34 is positioned at the stand-by position. Recesses 78 into which tip portions of the positioning pins 76 are inserted are formed in the side surfaces 70B of the rollers 70.

When the rollers 70 are positioned at the separation position, the positioning pins 76 are in an inserted state in which the positioning pins 76 are inserted into the recesses 78 (see FIG. 8A). On the other hand, when the rollers 70 are positioned at the contact position, the positioning pins 76 are in a withdrawn state in which the positioning pins 76 are withdrawn from the recesses 78 (see FIG. 8B).

A restricting-member windup device (not illustrated) is provided to each roller 70. The restricting-member windup device is used to maintain tension within a predetermined range, the tension being exerted on the sheet restricting member 34A during movement of the roller 70 between the separation position and the contact position.

In the above configuration, in order to keep the trailing-end gripper 34 to stand by at the stand-by position, the controlling unit 20 controls the solenoids 74 such that the rollers 70 are positioned at the separation position. Here, the positioning pins 76 are in the inserted state and the trailing-end gripper 34 is positioned at the stand-by position.

On the other hand, in order to rotate the trailing-end gripper 34 together with the transfer drum 30, the controlling unit 20 controls the solenoids 74 such that the rollers 70 are moved to the contact position. Consequently, the meshing portions 72A and the meshed portions 72B illustrated in FIG. 9 mesh with each other and thus a rotary force of the transfer drum 30 is transmitted to the rollers 70 via the joining systems 72. Here, the positioning pins 76 are in the withdrawn state and thus the trailing-end gripper 34 is rotatable around the rotation shaft 30A.

As illustrated above, as a result of movement of the rollers 70 in the drum-axis direction, a rotary force of the transfer drum 30 is transmitted to the rollers 70.

Since the rotary force is directly transmitted from the transfer body 30 to the rollers 70, accuracy in positioning of the trailing-end gripper 34 relative to the transfer drum 30 in terms of the circumferential direction of the transfer drum 30 is effectively improved.

Since the rotary force is transmitted from the transfer drum 30 to the rollers 70 by moving the rollers 70, transmission of the rotary force from the transfer drum 30 to the rollers 70 is achieved by a simple configuration. Other operations are the same as those in the first exemplary embodiment.

### Third Exemplary Embodiment

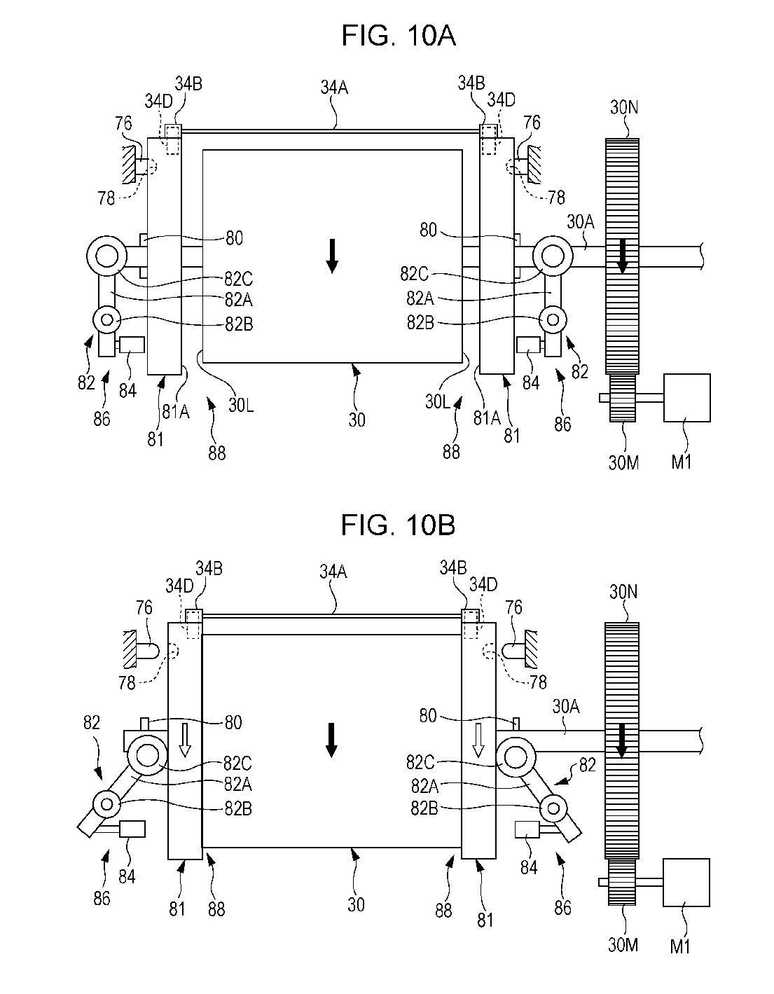

Referring now to FIGS. 10A and 10B, an image forming apparatus according to a third exemplary embodiment of the invention will be described. Components that are the same as those in the second exemplary embodiment will be denoted by the same reference symbols and description thereof is not provided.

As illustrated in FIGS. 10A and 10B, a pair of rollers 81 according to the third exemplary embodiment are examples of a pair of components, and the end portions of the protectors 34B are secured to the rollers 81. The rollers 81 each have no meshed portion on a side surface 81A that faces the transfer drum 30. Likewise, no meshing portion is formed on side surfaces 30L of the transfer drum 30.

Stopper rings 80 with which the rollers 81 come into contact and thus are positioned at the separation position are mounted on the rotation shaft 30A. Urging members (not illustrated) that urge the rollers 81 so that the rollers 81 come into contact with the stopper rings 80 are also provided.

Pressing members 82 are disposed on sides that are opposite the transfer drum 30 with respect to the rollers 81. The pressing members 82 are used to move the rollers 81 to the contact position.

The pressing members 82 have a longitudinal shape that extends in a direction intersecting the drum-axis direction. Each pressing member 82 includes a shaft 82B at its central portion in the longitudinal direction. The shaft 82B rotatably supports a body 82A of the pressing member 82. The shaft 82B is secured to a frame member, which is not illustrated. A bearing 82 is attached to a tip portion of the body 82A.

Solenoids 84, which push and pull the base-end side of the bodies 82A, are disposed near base ends of the bodies 82A. Specifically, the solenoids 84 pull the base-end side of the bodies 82A when electric currents are not passed through the solenoids 84, while push the base-end side of the bodies 82A when electric currents are passed through the solenoids 84.

In this configuration, the controlling unit 20 controls the solenoids 84 such that the bearings 82C of the pressing members 82 are separated from the rollers 81. Thus, the rollers 81 are positioned by urging forces of the urging members at the separation position (see FIG. 10A) at which the rollers 81 are separated from the transfer drum 30.

On the other hand, the controlling unit 20 controls the solenoids 84 such that the pressing members 82 are rotated and thus the bearings 82C push the rollers 81 toward the transfer drum 30. Consequently, the rollers 81 move in the drum-axis direction to the contact position (see FIG. 10B), so that the side surfaces 81A of the rollers 81 contact the side surfaces 30L of the transfer drum 30.

Friction generated between the side surfaces 81A and the side surfaces 30L enables transmission of the rotary force of the transfer drum 30 to the rollers 81. While the rollers 81 rotate, the bearings 82C of the pressing members 82 also rotate, and thus the rotation of the rollers 81 is not impeded by the pressing members 82.

Moving systems 86, which are examples of moving members that move the rollers 81 toward or away from the transfer drum 30, each include a pressing member 82, a solenoid 84, and an urging member, which are described above. Joining systems 88 joining the rollers 81 to the transfer drum 30 each include a side surface 81A and a side surface 30L.

As described above, a rotary force is transmitted from the transfer drum 30 to the rollers 81 with the frictional forces generated between the side surfaces 81A and the side surfaces 30L. This eliminates looseness due to backlash or the like unlike in the case where the rotary force is transmitted by causing components to engage with each other. Other operations are the same as those in the second exemplary embodiment.

### Fourth Exemplary Embodiment

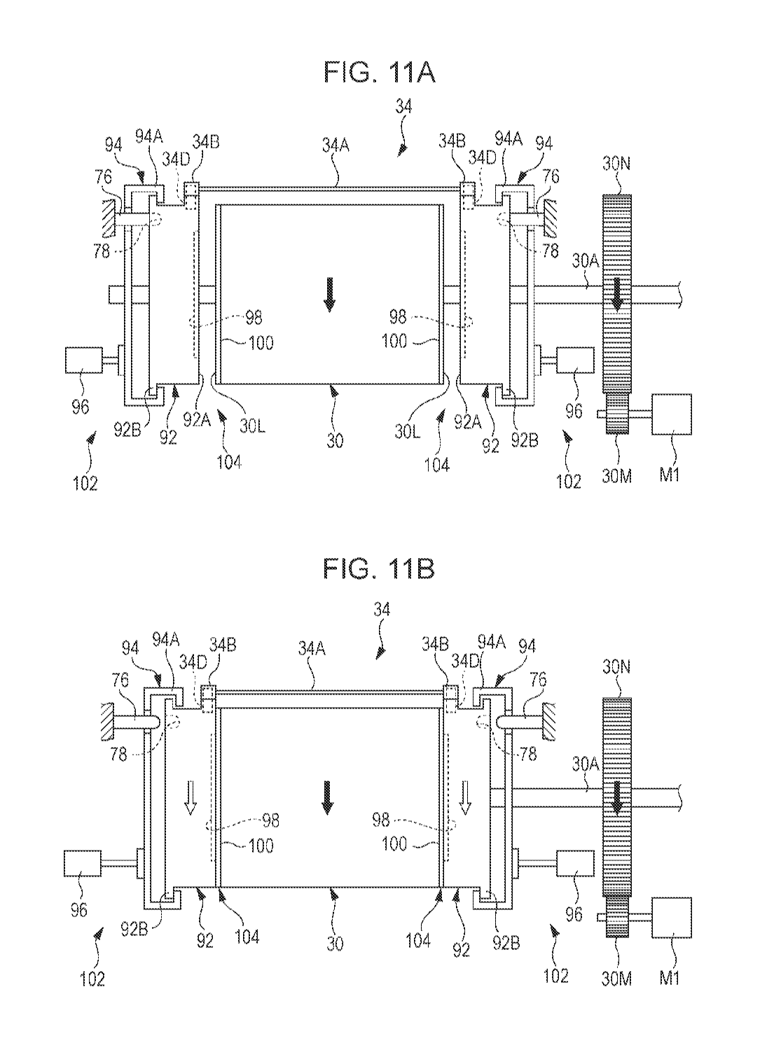

Referring now to FIGS. 11A and 11B, an image forming apparatus according to a fourth exemplary embodiment of the invention will be described. Components that are the same as those in the second exemplary embodiment are denoted by the same reference symbols and description thereof is not provided.

As illustrated in FIGS. 11A and 11B, disk-shaped magnets 98 are attached to side surfaces 92A of rollers 92 according to the fourth exemplary embodiment that face the transfer drum 30, the rollers 92 being examples of a pair of components to which base end portions of the protectors 34B are secured. Side surfaces 30L of the transfer drum 30 that face the side surfaces 92A are constituted by disk-shaped iron plates 100, which are magnetic bodies that are attracted by the magnetic force of the magnets 98.

Each roller 92 has an annular projection portion 92B that protrudes in its radial direction from its outer circumferential surface on an outer side (that is away from the transfer drum 30) in the drum-axis direction.

A roller holding member 94 including a gripping member 94A is disposed on a side that is further outward than each roller 92 in the drum-axis direction. The gripping member 94A restricts the projection portion 92B so as to hold the projection portion 92 from the outside. The roller holding member 94 is supported by a supporting member (not illustrated) so as to be movable in the drum-axis direction.

Solenoids 96 that move the roller holding members 94 in the drum-axis direction are disposed on sides that are further outward than the roller holding members 94 in the drum-axis direction. Specifically, the roller holding members 94 are moved outward in the drum-axis direction when electric currents are not passed through the solenoids 96, while the roller holding members 94 are moved inward in the drum-axis direction when electric currents are passed through the solenoids 96.

In this configuration, the controlling unit 20 controls the solenoids 96 such that the roller holding members 94 are moved outward in the drum-axis direction. With this control, the rollers 92 that are apt to move inward in the drum-axis direction due to the magnetic force between the magnets 98 and the iron plates 100 are moved outward in the drum-axis direction and positioned at a separation position (see FIG. 11A) at which the rollers 92 are separated from the transfer drum 30.

On the other hand, the controlling unit 20 controls the solenoids 96 such that the roller holding members 94 are moved inward in the drum-axis direction. With this control, the roller holding members 94 stop restricting the projection portions 92B and thus the rollers 92 move inward in the drum-axis direction due to the magnetic forces generated between the magnets 98 and the iron plates 100, so that the side surfaces 92A of the rollers 92 and the side surfaces 30L of the transfer drum 30 are brought into contact with each other due to the magnetic forces. Consequently, the rollers 92 are moved to the contact position (see FIG. 11B).

In this state, the gripping members 94A and the projection portions 92B are separated from each other in the drum-axis direction. The side surfaces 92A and the side surfaces 30L are joined to each other by the magnetic forces generated between the magnets 98 and the iron plates 100, so that the rotary force of the transfer drum 30 is transmitted to the rollers 92.

Moving systems 102, which are examples of moving members that move the rollers 92 toward or away from the transfer drum 30, each include a roller holding member 94 and a solenoid 96, which are described above. The joining systems 104 that join the rollers 92 to the transfer drum 30 each include a magnet 98 and an iron plate 100.

As described above, the transfer drum 30 and the rollers 92 are joined to each other by the magnetic forces generated between the magnets 98 and the iron plates 100 to transmit a rotary force from the transfer drum 30 to the rollers 92. This eliminates looseness due to backlash or the like unlike in the case where the rotary force is transmitted by causing components to engage with each other. Other operations are the same as those in the second exemplary embodiment.

### Fifth Exemplary Embodiment

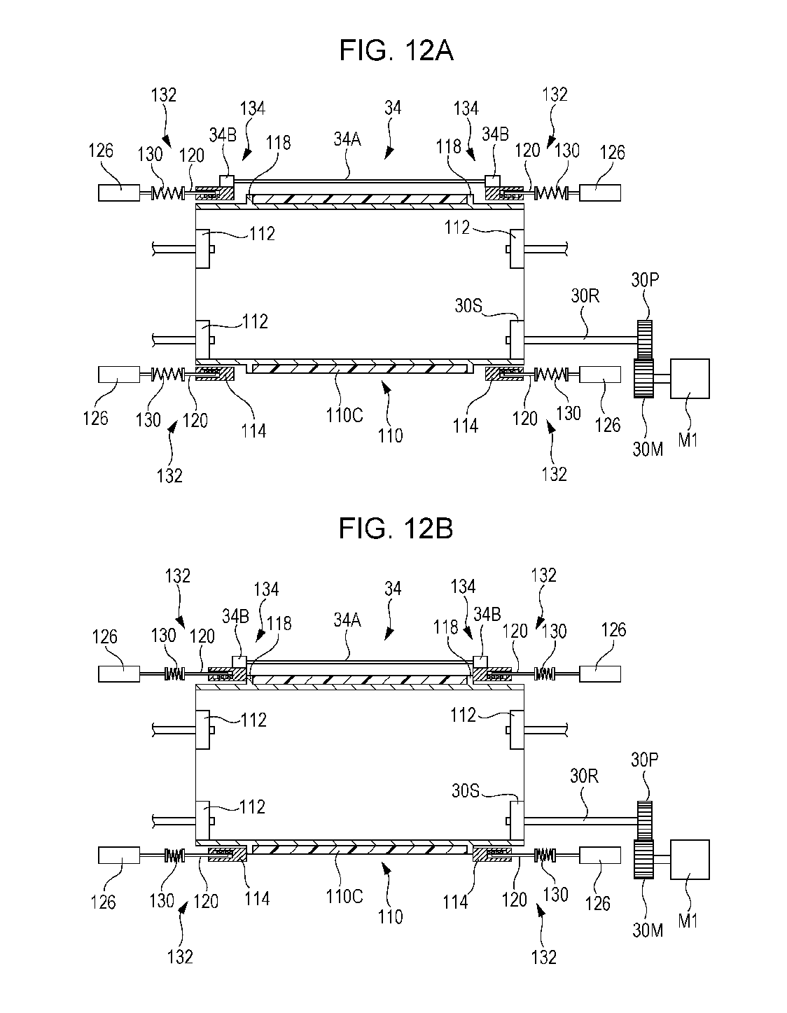

Referring now to FIGS. 12A to 14, an image forming apparatus according to a fifth exemplary embodiment of the invention will be described. Components that are the same as those in the second exemplary embodiment will be denoted by the same reference symbols and description thereof is not provided.

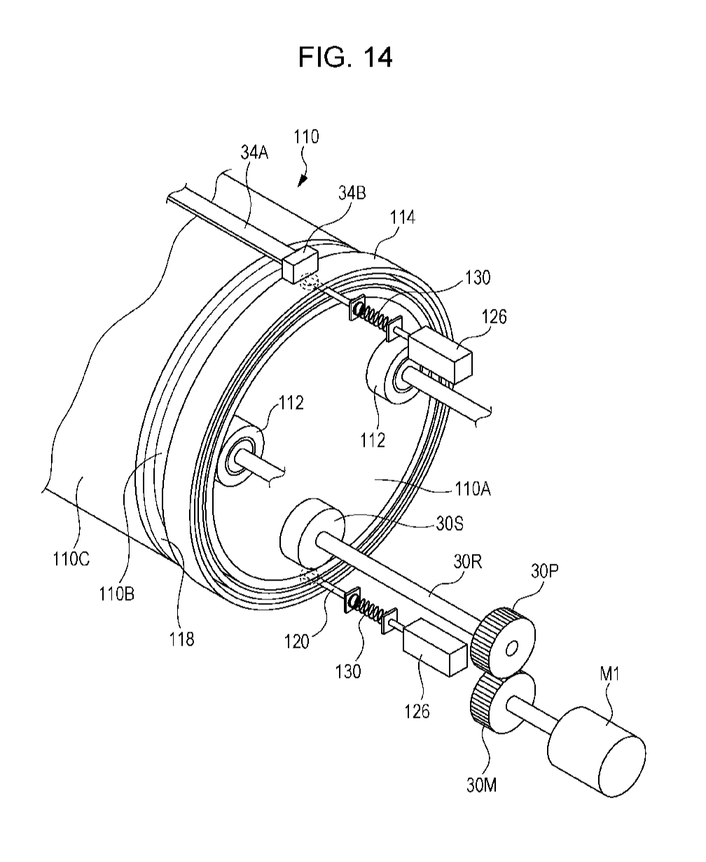

As illustrated in FIGS. 12A, 12B, and 14, a transfer drum 110 according to the fifth exemplary embodiment is cylindrical and has no end-closing side plate, and thus its inside is accessible.

As illustrated in FIG. 14, two driven rollers 112 are disposed on a first side of the transfer drum 110 in the drum-axis direction. The driven rollers 112 contact an inner circumferential surface 110A of the transfer drum 110 and are driven to rotate together with rotation of the transfer drum 110.

In addition, a gear 30P that meshes with a gear 30M, which is mounted on an output shaft of a driving motor M1, is mounted on one end of a rotation shaft 30R extending in the drum-axis direction. A roller 30S that contacts the inner circumferential surface 110A is mounted on another end of the rotation shaft 30R.

The roller 30S and the two driven rollers 112 are disposed so as to serve as vertexes of an equilateral triangle when seen in the drum-axis direction.

On a second side of the transfer drum 110 in the drum-axis direction, a driven roller 112 is disposed instead of a roller 30S. In other words, three driven rollers 112 are disposed on the second side of the transfer drum 110 in the drum-axis direction.

A pair of rollers 114 according to the fifth exemplary embodiment, which are examples of a pair of components, to which base end portions of the protectors 34B are secured have a cylindrical shape, and are disposed so as to cover both end portions of an outer circumferential surface 110B of the transfer drum 110. The rollers 114 are movable in the drum-axis direction along the outer circumferential surface 110B.

Annular projection portions 118, which protrude outward in the drum-radius direction, are formed on the outer circumferential surface 110B of the transfer drum 110 at both end portions in the drum-axis direction so as to face end faces of the rollers 114. An elastic layer 110C that supports a sheet medium P is disposed between the pair of the projection portions 118.

Two rods 120 that extend outward in the drum-axis direction from the inside of the rollers 114 are disposed so as to face each other with respect to the rotation axis of the transfer drum 110.

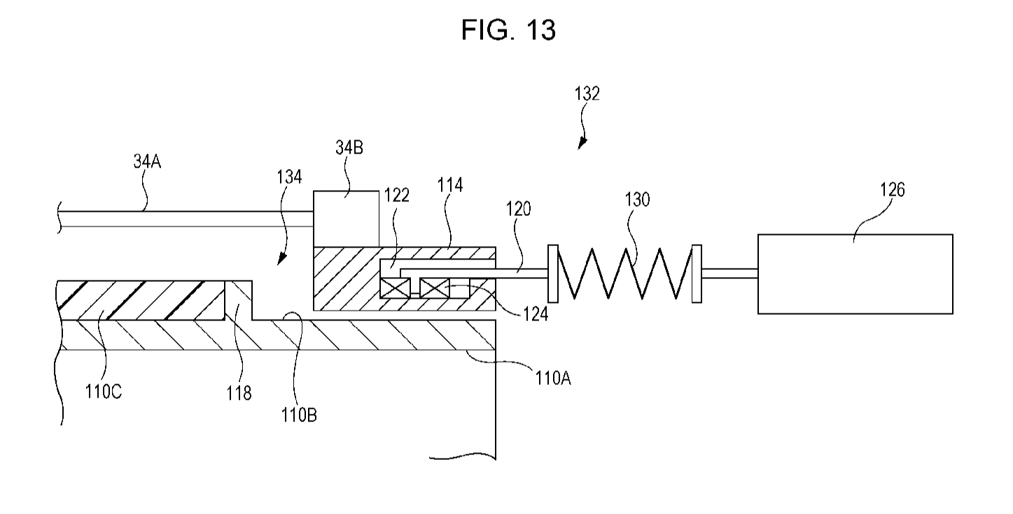

As illustrated in FIG. 13, a tip end portion of each rod 120 is disposed in an annular hollow portion 122 formed inside a corresponding roller 114. A bearing 124, which rotates together with rotation of the roller 114 while contacting a wall surface of the hollow portion 122, is attached to the tip end portion of each rod 120.

A base end portion of each rod 120, on the other hand, is attached to a solenoid 126 that moves the rod 120 in the drum-axis direction. Further, a compression spring 130 is disposed between the solenoid 126 and the rod 120. Specifically, the rod 120 is moved outward in the drum-axis direction when an electric current is not passed through the solenoid 126, while the rod 120 is moved inward in the drum-axis direction when an electric current is passed through the solenoid 126.

In this configuration, the controlling unit 20 controls the solenoids 126 such that the rods 120 are moved outward in the drum-axis direction, as illustrated in FIG. 12A. With this control, the bearings 124 come into contact with wall surfaces of the hollow portions 122 and the rollers 114 are moved outward in the drum-axis direction to the separation position (see FIG. 12A) at which the rollers 114 become separated from the projection portions 118 of the transfer drum 30.

On the other hand, as illustrated in FIG. 12B, the controlling unit 20 controls the solenoids 126 such that the rods 120 are moved inward in the drum-axis direction. With this control, the rollers 114 are moved inward in the drum-axis direction to the contact position (see FIG. 12B) at which the rollers 114 contact the projection portions 118 at their end surfaces.

When the rollers 114 are moved to the contact position, the rollers 114 are sandwiched between the solenoids 126 and the projection portions 118 while the compression springs 130 are compressed. Here, the end surfaces of the rollers 114 are pressed against the projection portions 118 by the urging forces of the compression springs 130.

In this state, the rollers 114 and the transfer drum 110 are joined to each other with frictional forces generated between the end surfaces of the rollers 114 and the projection portions 118 to transmit a rotary force of the transfer drum 110 to the rollers 114.

Moving systems 132, which are examples of moving members that move the rollers 114 toward or away from the transfer drum 110, each include a rod 120 and a solenoid 126. Joining systems 134 that join the rollers 114 to the transfer drum 110 each include a projection portion 118 and compression springs 130.

As described above, a rotary force is transmitted from the transfer drum 110 to the rollers 114 by the frictional forces generated between the end surfaces of the rollers 114 and the projection portions 118. This eliminates looseness due to backlash or the like unlike in the case where the rotary force is transmitted with engagement of components.

The transfer drum 110 has no end-closing side plate, consequently its inside is accessible. This allows components to be disposed inside the transfer drum 110.

The components are allowed to be disposed inside the transfer drum 110, thereby reducing the size of the apparatus.

The configuration in which the rollers 114 move in the drum-axis direction saves space in the drum-radius direction. Other operations are the same as those in the second exemplary embodiment.

### Sixth Exemplary Embodiment

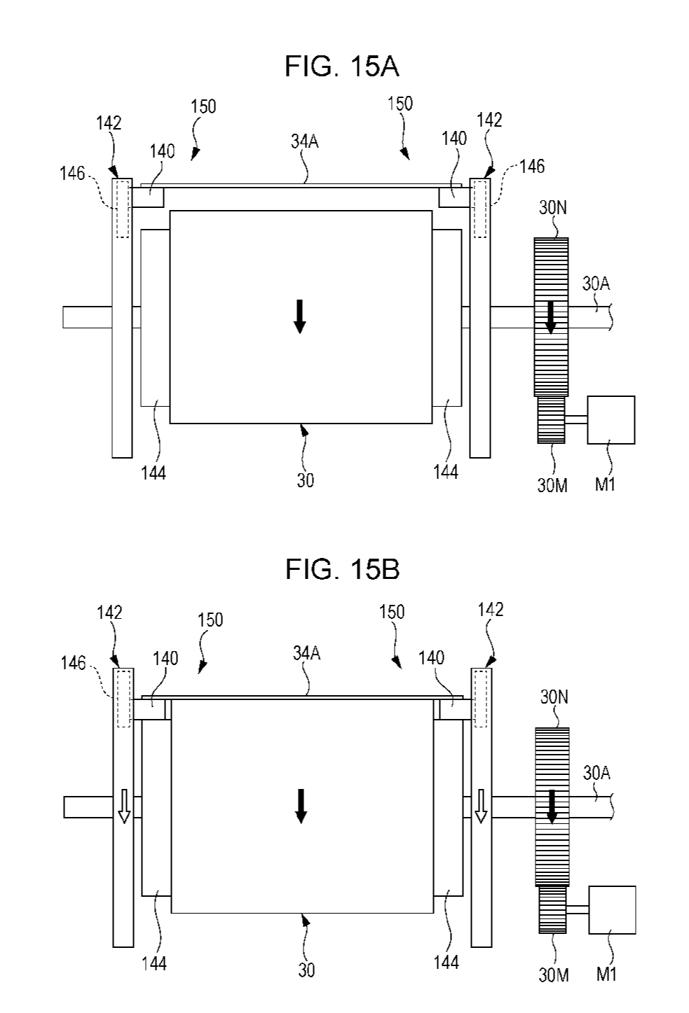

Referring now to FIGS. 15A and 15B, an image forming apparatus according to a sixth exemplary embodiment of the invention will be described. Components that are the same as those in the second exemplary embodiment will be denoted by the same reference symbols and description thereof is not provided.

As illustrated in FIGS. 15A and 15B, a pair of holding portions 140 according to the sixth exemplary embodiment to which both end portions of the sheet restricting member 34A are attached are provided. The holding portions 140 are examples of a pair of components, and the sheet restricting member 34A is an example of a restricting member. The holding portions 140 are supported by rollers 142 from the outer sides of the holding portions 140 in the drum-axis direction, the rollers 142 being rotatable relative to the rotation shaft 30A.

The transfer drum 30 also includes a pair of small-diameter portions 144 that have a smaller diameter than a normal portion of the transfer drum 30 such that the small-diameter portions 144 face the holding portions 140 in the drum-radius direction.

Solenoids 146 are disposed inside the rollers 142. The solenoids 146 are examples of moving members that move the holding portions 140 in the drum-radius direction toward or away from the small-diameter portions 144. Specifically, the holding portions 140 are moved outward in the drum-radius direction when electric currents are not passed through the solenoids 146, and the holding portions 140 are moved inward in the drum-radius direction when electric currents are passed through the solenoids 146.

With this configuration, the controlling unit 20 controls the solenoids 146 such that the holding portions 140 become separated from the small-diameter portions 144. With this control, the holding portions 140 are positioned at the separation position (see FIG. 15A) at which the holding portions 140 are separated from the transfer drum 30.

Here, the sheet restricting member 34 is at the releasing state.

On the other hand, the controlling unit 20 controls the solenoids 146 such that the holding portions 140 are moved inward in the drum-radius direction. With this control, the holding portions 140 are moved to the contact position (see FIG. 15B) at which the holding portions 140 contact the small-diameter portions 144. Consequently, the rotary force of the transfer drum 30 is transmitted to the trailing-end gripper 34 due to the frictional forces generated between the end surfaces of the holding portions 140 and the outer circumferential surfaces of the small-diameter portions 144.

Here, the sheet restricting member 34A is switched to the restricting state.

Joining systems 150 that join the holding portions 140 to the transfer drum 30 each include a small-diameter portion 144.

As described above, the controlling unit 20 controls the solenoids 146 such that the sheet restricting member 34A is switched between the releasing state and restricting state together with movement of the holding portions 140 between the separation position and the contact position.

Other operations are the same as those in the second exemplary embodiment.

Although the present invention has been described in detail on the basis of specific exemplary embodiments, it is obvious to those skilled in the art that the present invention is not limited to the exemplary embodiments and that various other exemplary embodiments may be made within the scope of the invention. Although solenoids are used to move target objects in the exemplary embodiments, other devices such as a cam may be used to move the target objects.

Although the meshed portions 72B according to the second exemplary embodiment are described as having an arc shape, an annular meshed portion may be used instead.

Although not particularly described, surfaces between which friction is generated may be rough surfaces to increase frictional resistance in the third, fifth, and sixth exemplary embodiments. In this case, the rotary force is transmitted with higher efficiency.

Although the holding portions 140 and the small-diameter portions 144 are joined to each other with frictional forces in the sixth exemplary embodiment, these portions 140 and 144 may be joined to each other by using mechanical engagement, a magnetic force, or by other methods.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier on whose surface toner images are sequentially formed while the image carrier is rotating;
a transfer body around whose outer circumferential surface a recording medium is wrapped, the transfer body transporting the recording medium to a transfer position, at which the recording medium faces the image carrier, a plurality of times in order to sequentially transfer the toner images formed on the surface of the image carrier to the recording medium while the image carrier is rotating;
a trailing-end restricting member that is movable relative to the transfer body in a circumferential direction of the transfer body, the trailing-end restricting member rotating together with the transfer body when restricting a position of a trailing end portion of the recording medium wrapped around the transfer body;
a driving member that rotates the transfer body; and
a transmitting device that transmits a rotary force, with which the driving member rotates the transfer body, to the trailing-end restricting member when the trailing-end restricting member is rotated together with the transfer body.

2. The image forming apparatus according to claim 1,
wherein the transmitting device includes
a moving member that moves a component constituting at least part of the trailing-end restricting member toward or away from the transfer body, and
a joining system that joins the component to the transfer body such that the rotary force is transmittable as a result of the moving member bringing the component into contact with the transfer body.

3. The image forming apparatus according to claim 2, wherein the moving member moves the component in a rotation axis direction of the transfer body.

4. The image forming apparatus according to claim 2, wherein the moving member moves the component in a radial direction of the transfer body.

5. The image forming apparatus according to claim 4,
wherein the trailing-end restricting member includes
the component, and
a restricting portion that is disposed on the component, the restricting portion being capable of switching between a releasing state, in which the restricting portion is separated from the trailing end portion of the recording medium to release the trailing end portion as a result of the component moving outward in the radial direction of the transfer body, and a restricting state, in which the restricting portion contacts the trailing end portion of the recording medium to restrict the position of the trailing end portion of the recording medium as a result of the component moving inward in the radial direction of the transfer body, and
wherein the restricting portion that is in the releasing state switches to the restricting state at the time when the joining system joins the component to the transfer body.
